(19) United States
(12) Patent Application Publication
(10) Pub. No.: US 2004/0158546 A1
(43) Pub. Date: Aug. 12, 2004

(54) Integrity checking for software downloaded from untrusted sources

(76) Inventors: William E. Sobel, Stevenson Ranch, CA (US); Bruce McCorkendale, Los Angeles, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/359,922

(22) Filed: Feb. 6, 2003

(51) Int. Cl. G06F 17/30

(52) U.S. Cl. 707/1; 713/176

(57) ABSTRACT

Computer-implemented methods, apparati, data structures, and computer-readable media for downloading a target file (1) quickly and securely from a source computer (2). The target file (1) is broken up into a plurality of chunks (12). The integrity of each chunk (12) is verified (25) by calculating a digest for each chunk (12) and comparing the calculated digest with a prestored digest (32) for that chunk (12). In several embodiments, a manifest file (3) is created. In these embodiments, the manifest file (3) contains the digest (32) for each chunk (12).

### TECHNICAL FIELD

This invention pertains to the field of facilitating software downloads in a fast and secure manner, even when the software is downloaded from an untrusted source.

### BACKGROUND ART

To defray the high administrative costs associated with file hosting, software publishers often outsource file hosting to third parties, such as mirroring companies. However, the bandwidth cost for third party hosting can be very expensive. To reduce bandwidth costs, software publishers can post the computer files to be downloaded on public peer-to-peer (P2P) networks, Newsgroup servers, etc. All of these alternatives to self-hosting leave posted data vulnerable to tampering, or, equivalently, to redirection via DNS (Domain Name Server) spoofing or some other technique that causes the same effect—the downloading user does not get the data that was intended. Providing digital signatures along with the posted data can allow the downloading client computer to verify the integrity of the data once the data and the digital signature have been downloaded. However, malicious persons may purposefully corrupt data on P2P type networks just to cause a denial of service to the clients. For example, the malicious person could replace the intended data with data that is very large, causing the client computer to take an inordinate amount of time to perform the download. In a typical implementation of integrity checking for such data, the data has to be completely downloaded before verifying its integrity using its corresponding digital signature. When the data to be downloaded is security-related (such as virus definitions, firewall rules, intrusion detection signatures, etc.), a malicious attacker may combine a virus/hacking attack with such a denial of service attack on the security vendor's data that would be used to protect against the attack.

What is needed is a fast and secure method by which a software publisher may post a target computer file to be downloaded, so that the download remains fast and secure even when the source computer hosting the file to be downloaded is untrusted.

### DISCLOSURE OF INVENTION

Computer-implemented methods, apparati, data structures, and computer-readable media for downloading a target file (1) quickly and securely from a source computer (2). The target file (1) is broken up into a plurality of chunks (12). The integrity of each chunk (12) is verified (25) by calculating a digest for each chunk (12) and comparing the calculated digest with a prestored digest (32) for that chunk (12). In several embodiments, a manifest file (3) is created. In these embodiments, the manifest file (3) contains the digest (32) for each chunk (12).

### BRIEF DESCRIPTION OF THE DRAWINGS

These and other more detailed and specific objects and features of the present invention are more fully disclosed in the following specification, reference being had to the accompanying drawings, in which:

FIG. 1 is a block diagram showing components of the present invention.

FIG. 2 illustrates an embodiment of manifest file 3 that is used when manifest file computer 4 is untrusted.

FIG. 3 illustrates an alternative embodiment of manifest file 3 that is used when computer 4 is untrusted.

FIG. 4 is a flow diagram illustrating a method embodiment for downloading target file 1.

FIG. 5 is a flow diagram illustrating a method embodiment for downloading manifest file 3.

FIG. 6 illustrates an alternative embodiment of target file 1 that can be used when manifest file 3 is not present.

FIG. 7 is a flow diagram illustrating a method embodiment for downloading target file 1 when manifest file 3 is not present.

### DETAILED DESCRIPTION OF THE PREFERRED EMBODIMENTS

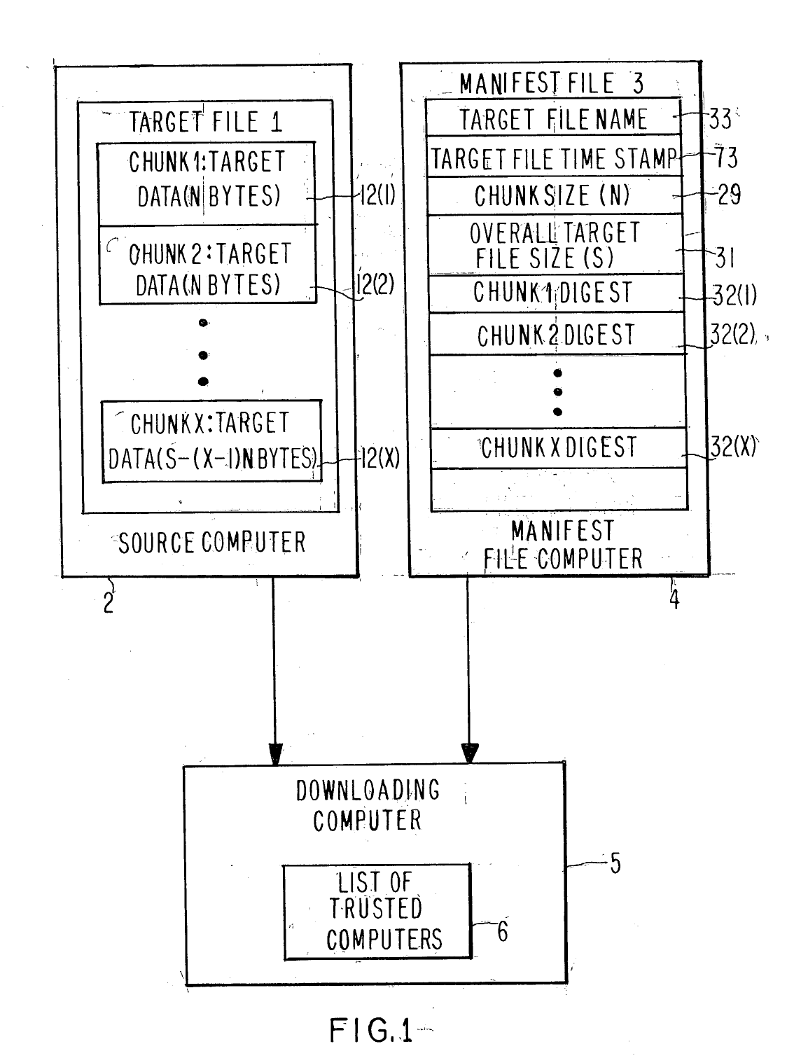

With reference to FIG. 1, a software publisher posts a target file 1 on a source (server) computer 2 with the intent that the target file 1 be subsequently downloaded by a downloading (client) computer 5. Target file 1 can comprise any digital content whatsoever, including executable code, music, movies, multi-media, large text documents, etc. Furthermore, as used herein, “software publisher” is used in the broad sense to include any entity that creates, authors, sponsors, or posts any digital content that can be included in a target file 1. Source computer 2 and downloading computer 5 may be coupled over any type of coupling or connection, such as the Internet, a college dormitory LAN (local area network), an enterprise LAN, a VPN (virtual private network), or any other type of open or closed network.

The same target file 1 may be posted on a plurality of source computers 2. This may be done to facilitate the dissemination of target file 1 to a large number of downloading computers 5 as part of the overall marketing plan of the software publisher.

In the present invention, the software publisher breaks up target file 1 into a plurality X of chunks 12. As used throughout this specification including claims, “breaking up the target file into chunks” can mean breaking up target file 1 into physical chunks 12 and/or virtual chunks 12. When target file 1 is broken up into physical chunks 12, each chunk 12 becomes its own file 1. This allows simultaneous download of chunks 12 from different sources 2. When target file 1 is broken up into virtual chunks 12, the chunks 12 are all in the same file 1; in this embodiment, target file 1 is considered to be the collection of chunks 12.

Each chunk 12 typically has the same number (N) of bytes, where N is any positive integer greater than one. If S (the overall size of target file 1) is not evenly divisible by N, then we have a special case for the last chunk 12. For the last chunk 12, the chunk size is S mod N=S−(X−1)N. The last chunk 12 is likely to be truncated or padded.

In several embodiments, the software publisher creates a secure manifest file 3, and posts file 3 on a manifest file computer 4. Computer 4 may be the same computer as computer 2, or may be a different computer. In embodiments where manifest file 3 is present, downloading computer 5 first downloads manifest file 3, and uses file 3 to verify the integrity of target file 1 during the time that downloading computer 5 subsequently downloads file 1.

Manifest file 3 comprises a field 29 giving the chunk size N and a field 31 containing the size S in bytes of target file 1. Manifest file 3 further comprises a secure digest 32 of each chunk 12 of target file 1. The secure digest 32 is calculated by applying a preselected hash function (such as SHA-1) to each chunk 12. Manifest file 3 contains a field 33 giving the name of target file 1, and a field 73 giving a timestamp representing the time of creation or last update of target file 1. The purpose for having these two fields 33, 73 is to prevent replay/replacement attacks whereby an attacker could replace one intended file 1 for another. The digests 32 provide means for accomplishing internal integrity checking; thus, the data within a file 1 cannot be modified. However, wrong data could be associated with a given target file 1, unless suitable precautions are taken, such as providing fields 33 and 73.

Manifest file computer 4 may be a “trusted” computer, or an “untrusted” computer. Alternatively, manifest file 3 may be posted on at least one trusted computer 4 and on at least one untrusted computer 4. As used herein, a “trusted” computer means a computer that downloading computer 5 deems to be trusted (trustworthy). Alternatively, a “trusted” computer means a computer owned or controlled by the software publisher, or a computer owned or controlled by an entity authorized by the software publisher. Said entity may be a mirroring company such as Akamai Corporation. An “untrusted” computer is defined herein as a computer that is not “trusted”. Source computer 2 is usually an untrusted computer but it may be a trusted computer.

Downloading computer 5 may contain a list 6 of computers 4 that downloading computer 5 deems to be trusted. List 6 may be modified by computer 5 using a P2P (peer-to-peer) web of trust. As used herein, “P2P (peer-to-peer)” refers to a network of computers in which all computers have relatively the same amount of authority. In such a network, any computer can typically periodically act as a server (master) computer. Also as used herein, “web of trust” means any non-hierarchical scheme for implementing trust in a computer network. An example of a web of trust is the trust scheme used by the PGP (Pretty Good Privacy) encryption software. In this scheme, if computer A trusts computer B, and computer A trusts computer C, then computer A's good offices can be used to extend trust between computer B and computer C.

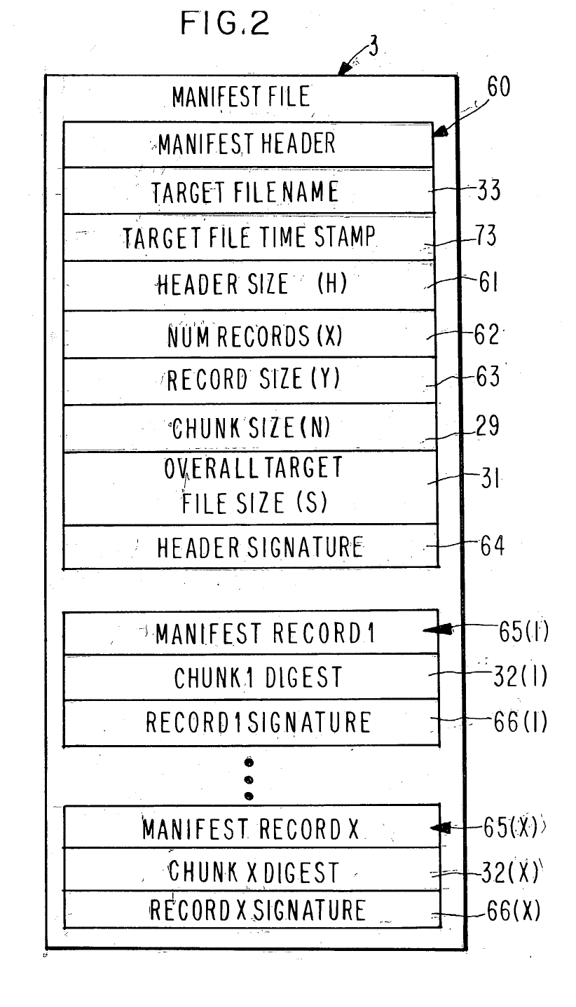

FIG. 2 illustrates an embodiment of manifest file 3 that is appropriate when file 3 is downloaded from an untrusted computer 4. In this embodiment, each digest 32 is individually digitally signed with a digital signature 66. The term “digital signature” as used throughout this application means a digital signature as that term is conventionally used in the field of public key cryptography. As used throughout this application, a digital signature may be affixed by the software publisher or by a trusted third party.

As illustrated in FIG. 2, the chunk digests 32 are organized into a set of X manifest records 65. Each record 65 comprises a chunk digest 32 and a corresponding digital signature 66. Manifest file 3 also comprises a header 60. The header comprises a field 33 giving the name of target file 1, a field 73 giving a timestamp of target file 1, a field 61 giving the header size H, a field 62 giving the number X of records in file 3, a field 63 containing the record size Y, a field 29 containing the chunk size N, a field 31 giving the overall target file size S, and a field 64 containing a digital signature of header 60. It is desirable to impose a preselected maximum on H, to counter a denial of service attack (in which a malicious entity tries to stuff header 60 with an arbitrarily large number of bytes).

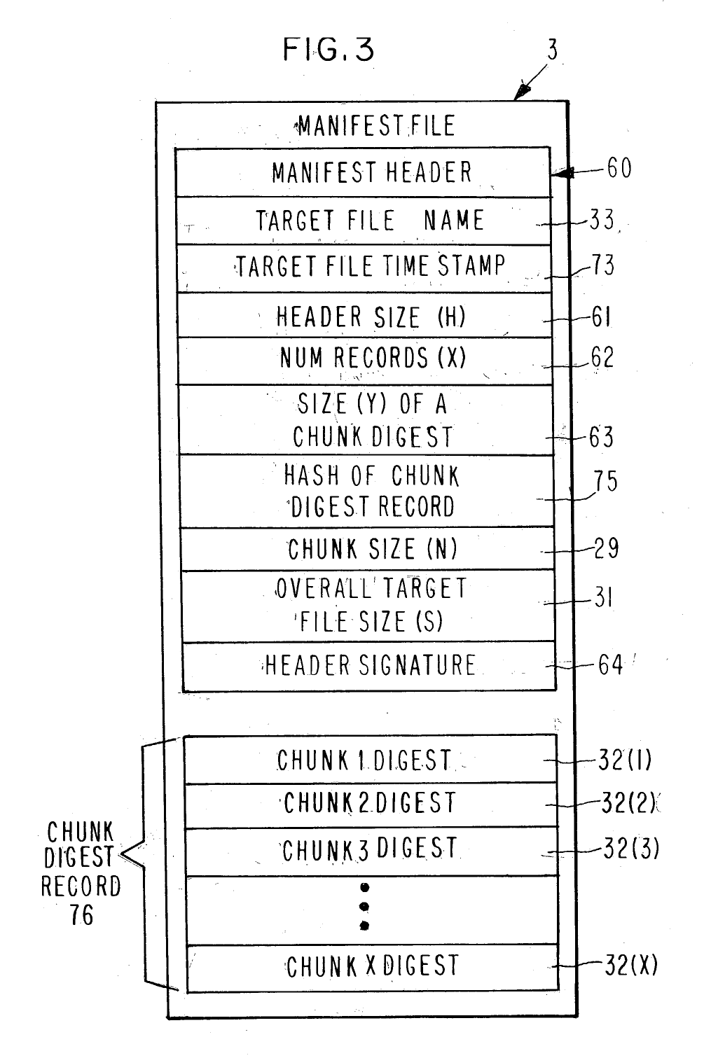

FIG. 3 illustrates an alternative embodiment of manifest file 3 that can be used when file 3 is downloaded from an untrusted computer 4. Note that the format of file 3 illustrated in FIG. 3 is identical to that illustrated in FIG. 2 with the following exceptions. In the FIG. 3 embodiment, the chunk digests 32 are not individually digitally signed. Rather, the chunk digests 32 are grouped together in a chunk digest record 76, and a field 75 is provided within header 60 giving a digest (hash) of the chunk digest record 76. Field 63 giving the record size Y now gives the size of a single chunk digest 32. It will be appreciated that this embodiment is somewhat simpler than the embodiment illustrated in FIG. 2.

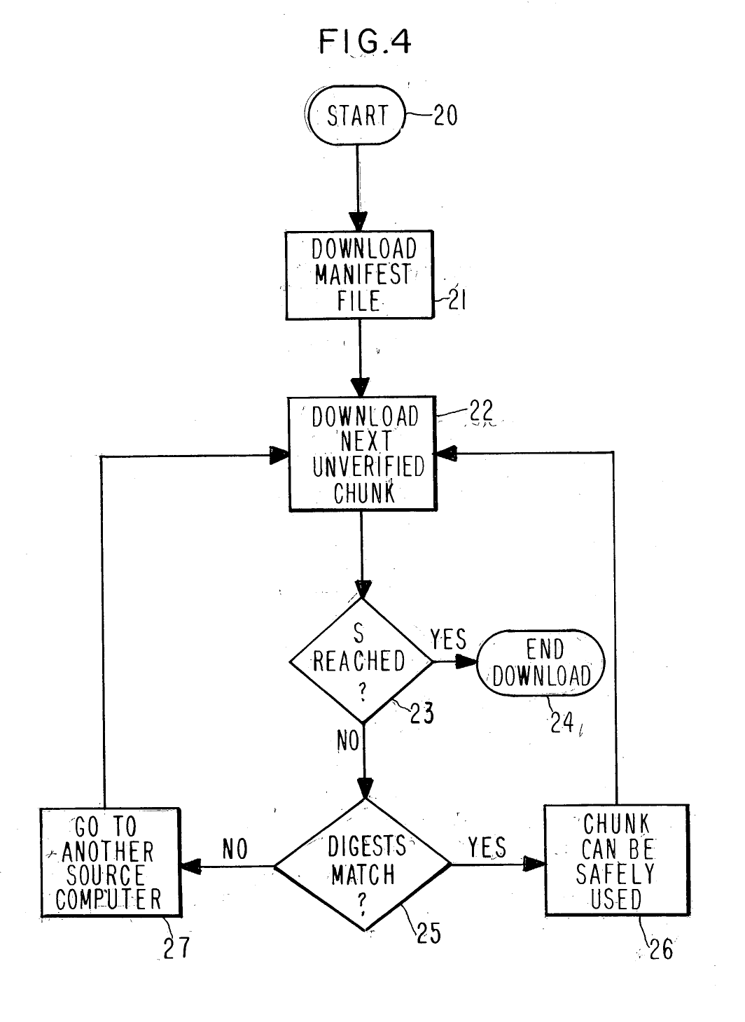

FIG. 4 illustrates a method embodiment for downloading target file 1. The method begins at step 20. At step 21, downloading computer 5 downloads manifest file 3 and extracts therefrom N and S. The step 21 of downloading the manifest file 3 may involve the setting up of an SSL (Secure Socket Layer) session between computers 4 and 5 for enhanced security. An SSL session entails encrypted as well as authenticated communications.

At step 22, downloading computer 5 downloads the next unverified chunk 12 of the target file 1 into a temporary holding area (buffer memory) associated with computer 5. The first time that step 22 is executed, the “next unverified chunk” is the first chunk 12.

At step 23, downloading computer 5 determines whether the limit S has been reached. If S (the overall size of target file 1) is not evenly divisible by N, then we have a special case for the last chunk 12. For the last chunk 12, the chunk size is S mod N=S−(X−1)N. An end-of-file marker can be used to flag the end of the file 1. If, at step 23, downloading computer 5 determines that the limit S has been reached, downloading computer 5 stops the downloading of target file 1 at step 24. In other words, the downloading process is deemed to be complete when the overall size of the downloaded chunks 12 reaches S, even if the actual size of the file 1 being downloaded exceeds S. The purpose of having this limit S is to avoid wasting time downloading extraneous data that may have been appended to target file 1 by a malicious entity perpetrating a denial of service attack.

At step 25, downloading computer 5 calculates a digest for the chunk 12 currently being processed, using the same hash function that was employed when digest 32 was initially calculated for purposes of storing same in file 3. If the digest calculated by computer 5 matches the stored digest 32, the current chunk 12 can safely be used by computer 5, and the method proceeds to step 26 where, for example, chunk 12 is moved from the temporary holding area to a more permanent location within computer 5. The method then reverts to step 22.

If, on the other hand, the digests do not match at step 25, the method proceeds to step 27, where computer 5 turns to a source computer 2 other than the computer 2 from which computer 5 has been downloading. The method then reverts to step 22, where the “next unverified chunk” 12 is defined to be the current chunk 12, i.e., the chunk 12 where the digests did not match. Thus, only chunks 12 subsequent to those already successfully downloaded and verified by computer 5 need to be retrieved from the subsequent source computer(s) 2.

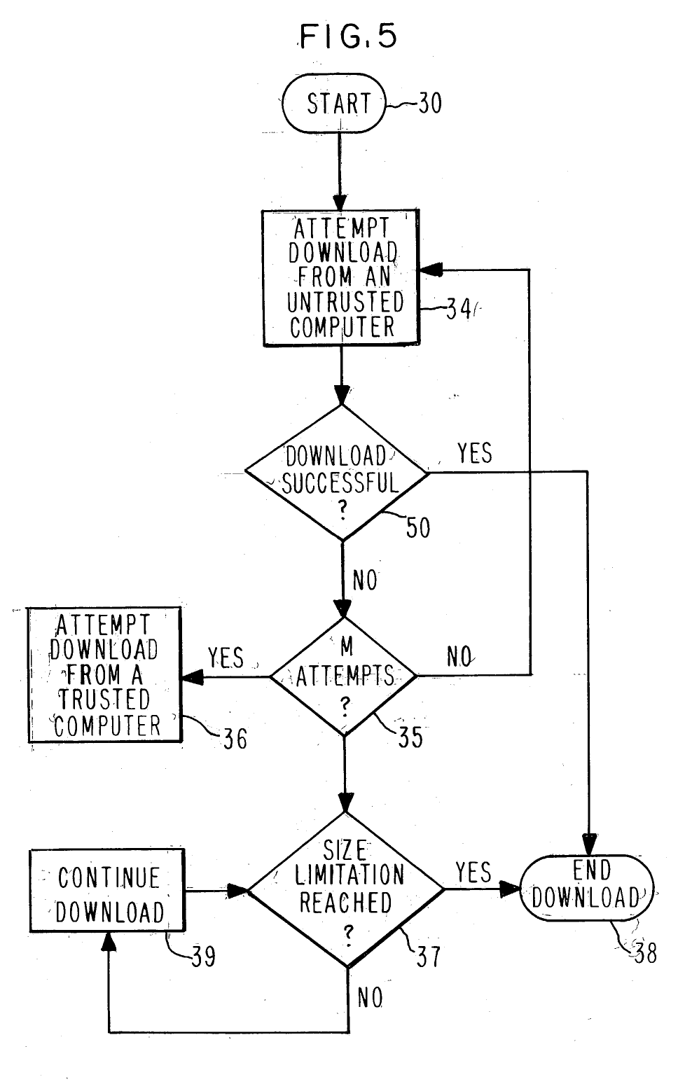

One embodiment for downloading manifest file 3, in which file 3 is posted on at least one trusted computer 4, and additionally is posted on at least one untrusted computer 4, is illustrated in FIG. 5. The method starts at step 30. At step 34, computer 5 first attempts to download the manifest file 3 from an untrusted computer 4. The reason for this is that it is expected that the download will be less expensive from an untrusted computer 4 than from a trusted computer 4. In this embodiment, M attempts are given to computer 5 to complete a successful download of manifest file 3 from an untrusted computer 4. M is any preselected positive integer. At step 50, computer 5 determines whether the download has been successful. If so, the download ends at step 38. If not, computer 5 determines at step 35 whether M attempts have been made. If not, step 34 is re-executed using a different untrusted computer 4. If the limit M has been reached, the method proceeds to step 36, where computer 5 attempts to download manifest file 3 from a trusted computer 4.

In this embodiment, a limitation may optionally be placed on the maximum permissible size of manifest file 3. Thus, at step 37, computer 5 determines whether this size limitation has been reached. If so, the download of manifest file 3 is ended at step 38, even if the entire contents of file 3 have not been downloaded. If the size limitation is not found to have been reached at step 37, the method proceeds to step 39, then back to step 37, continuing the download of manifest file 3 until the size limitation has been reached. As with the size limitation S placed on target file 1, as described above, this size limitation on manifest file 3 avoids wasting time when the manifest file 3 has been corrupted. The size limitation may be in the form of a total number of bytes J, where J is a preselected positive integer. In the FIG. 2 embodiment, J=H+XY. In lieu of the size limitation being in the form of a fixed number of bytes J, the download of manifest file 3 may be performed in a piecewise fashion, e.g., one record 65 at a time in the FIG. 2 embodiment.

Analogous to step 35, a limit may also be placed on the number of attempts that computer 5 is given when downloading target file 1 from source computer 2. Thus, computer 5 may be given Q attempts to download target file 1, where Q is any preselected positive integer. Q can be a function of the type of application contained within target file 1. For example, Q can be higher for a music file 1 than for a data file 1. Q can be made to be adjustable by the user of computer 5 and/or by the software publisher. Q can be a cumulative limit over all chunks 12 of the target file 1.

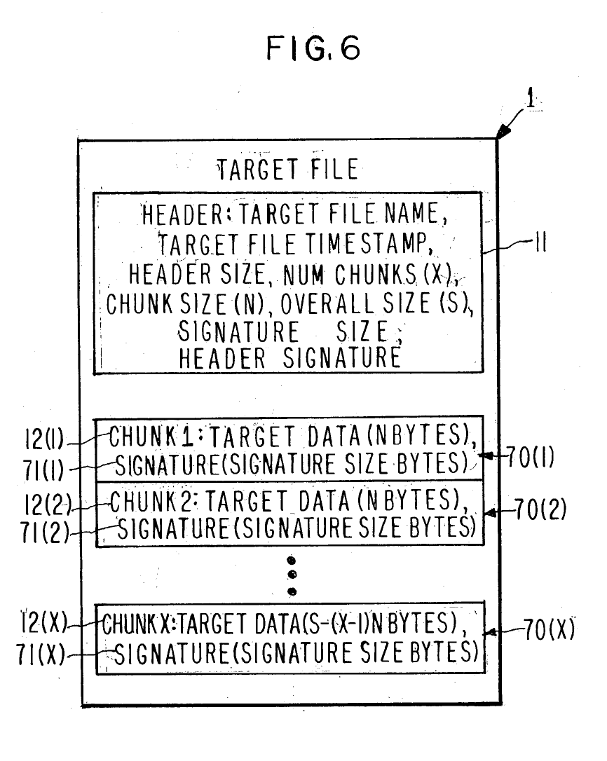

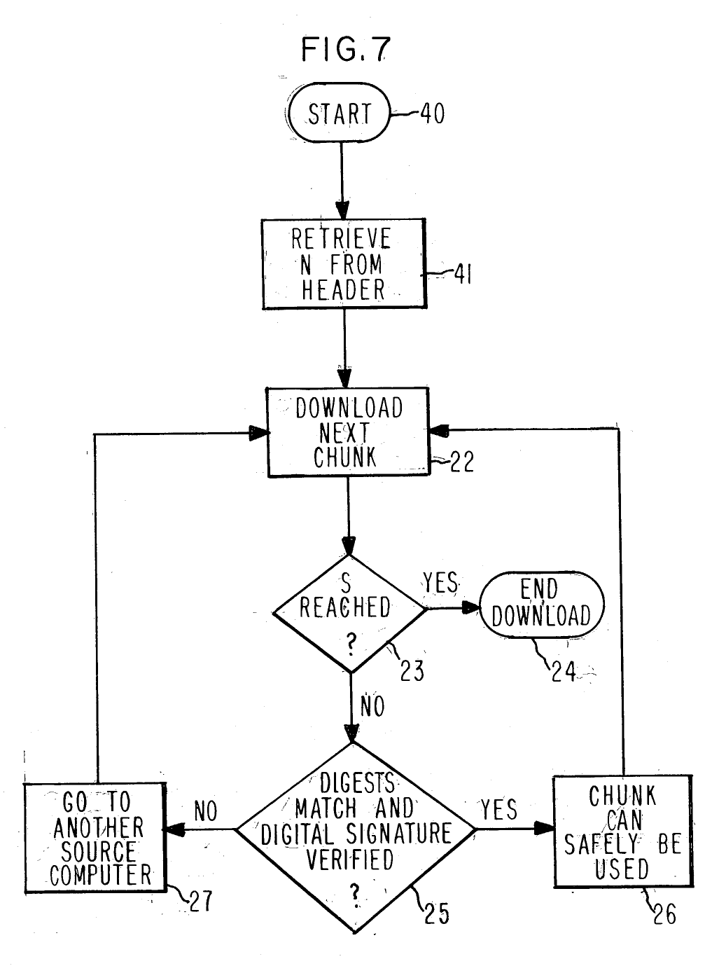

In alternative embodiments of the present invention, manifest file 3 is not used at all. In one such embodiment, the software publisher still breaks up target file 1 into a plurality of chunks 12, all but the last chunk 12 having N bytes, and, additionally, affixes a digital signature 71 to each chunk 12. Such a format for target file 1 is illustrated in FIG. 6. File 1 comprises a header 11 and X records 70. Each record 70 comprises a chunk 12 of target data and a digital signature 71 for that chunk 12. The header 11 contains the name of target file 1, a timestamp for target file 1, the header size, the number of chunks X, the chunk size N, the overall size S of file 1, the size of each signature 71, and a digital signature for header 11. Header 11 contains the overall file size S so that we can handle the case where the file size S is not an integral multiple of the chunk size N. Header 11 should not be larger than a preselected size, so that a malicious entity cannot undesirably stuff the header with an arbitrarily large number of bytes in an attempt to perpetrate a denial of service attack. In this embodiment, downloading computer 5 performs the method steps of FIG. 7, which is identical to the method of FIG. 4 as described above, except that step 21 is not performed, and step 25 entails the verification of the digital signature 71 of the current chunk 12 being processed, as well as the comparison of digests as described previously.

Alternative to the embodiment illustrated in FIG. 6, each record 70 could contain its own header that gives the size of that chunk 12.

In an alternative embodiment where target file 1 is used in the absence of manifest file 3, a FIG. 2 or FIG. 3 type of manifest file 3 is prepended to the FIG. 1 version of target file 1, i.e., all the contents of file 3 are inserted into file 1, typically at the beginning thereof.

The constituent elements of the present invention can be implemented in hardware, firmware, and/or software, and are usually implemented in software. The software can reside on any computer-readable medium such as a hard disk, floppy disk, CD, DVD, or other media now known or later developed.

The above description is included to illustrate the operation of the preferred embodiments and is not meant to limit the scope of the invention. The scope of the invention is to be limited only by the following claims. From the above discussion, many variations will be apparent to one skilled in the art that would yet be encompassed by the spirit and scope of the present invention.

What is claimed is:

1. A method by which a software publisher prepares a target file to be downloaded quickly and securely from a source computer, said method comprising the steps of:
breaking up the target file into a plurality of chunks; and
creating a manifest file comprising a digest for each chunk.

2. The method of claim 1 wherein:
all chunks other than a last chunk contain N bytes; and
the manifest file further comprises an overall number of bytes S of the target file.

3. The method of claim 1 wherein the manifest file is posted on a trusted computer.

4. The method of claim 3 wherein the trusted computer is a computer from the group of computers comprising a software publisher computer and a computer authorized by the software publisher.

5. The method of claim 3 wherein the trusted computer is a computer deemed to be trusted by a downloading computer that downloads the target file from the source computer.

6. The method of claim 5 wherein the downloading computer contains a list of trusted computers.

7. The method of claim 6 wherein the downloading computer modifies the list of trusted computers using a peer-to-peer web of trust.

8. The method of claim 1 wherein:
the manifest file is posted on an untrusted computer;
the manifest file contains a header; and
the header contains a preselected maximum number of bytes.

9. The method of claim 8 wherein the manifest file comprises a plurality of records, and each record is digitally signed.

10. The method of claim 8 wherein the manifest file contains a hash of the chunk digests taken as a whole.

11. The method of claim 1 wherein the manifest file is prepended to the target file.

12. The method of claim 1 wherein the manifest file is posted on at least one trusted computer and on at least one untrusted computer.

13. The method of claim 12 wherein a downloading computer first attempts to download the manifest file from an untrusted computer.

14. The method of claim 13 wherein the downloading computer has a preselected number M attempts to download the manifest file from an untrusted computer and, when the downloading computer is not able to download the manifest file from an untrusted computer in M attempts, the downloading computer attempts to download the manifest file from a trusted computer.

15. The method of claim 1 wherein a downloading computer first downloads the manifest file, then uses the manifest file to verify contents of the target file as the downloading computer downloads the target file.

16. The method of claim 15 wherein the downloading computer downloads no more than J bytes of the manifest file, where J is a preselected positive integer.

17. The method of claim 15 wherein the downloading computer downloads the manifest file in a piecewise fashion.

18. The method of claim 1 wherein each digest is calculated by applying a hash function to a chunk of the target file.

19. The method of claim 1 further comprising the step of a downloading computer verifying the digest of each chunk of the target file.

20. The method of claim 19 wherein the verifying comprises calculating a digest for that chunk and comparing the calculated digest with the digest for that chunk contained in the manifest file.

21. The method of claim 20 wherein a chunk is deemed to have integrity when the value of the digest calculated during the verifying step matches the value of the digest contained in the manifest file.

22. The method of claim 20 wherein, when the digest calculated during the verifying step does not match the digest contained in the manifest file, the chunk is deemed to lack integrity, and the downloading from that source computer is aborted.

23. The method of claim 22 wherein the downloading continues from an alternative source computer.

24. The method of claim 23 wherein only those chunks subsequent to chunks already downloaded and verified are retrieved from the alternative source computer.

25. The method of claim 1 wherein a downloading computer wishing to download the target file first downloads the manifest file using a SSL session.

26. The method of claim 1 wherein the manifest file contains a header and a digital signature for the header.

27. The method of claim 26 wherein the digital signature is affixed by the software publisher.

28. The method of claim 26 wherein the digital signature is affixed by a trusted third party.

29. The method of claim 1 wherein a downloading computer stops downloading the target file when S bytes of the target file have been downloaded.

30. The method of claim 1 wherein a downloading computer is given a preselected number Q attempts to download the target file.

31. A computer-readable medium containing computer program instructions for preparing a target file to be downloaded quickly and securely from a source computer, said computer program instructions performing the steps of:
breaking up the target file into a plurality of chunks; and
digitally signing each chunk.

32. The computer-readable medium of claim 31 wherein said computer program instructions further perform the steps of:
placing a chunk size into a header of the target file; and
imposing a maximum on the number of bytes in the header.

33. A computer-readable medium containing computer program instructions for preparing a target file to be downloaded quickly and securely from a source computer, said computer program instructions performing the steps of:
breaking up the target file into a plurality of chunks; and
creating a manifest file containing a digest for each chunk.

34. The computer-readable medium of claim 33 wherein:
the manifest file contains an overall size S of the target file; and
all chunks but a last chunk contain N bytes, where N is an integer greater than 1.

35. The computer-readable medium of claim 33 wherein the manifest file is prepended to the target file.

36. A method by which a downloading computer downloads a target file quickly and securely from a source computer, said method comprising the steps of:
piecewise downloading the target file in a plurality of chunks; and
verifying a digital signature for each chunk.

37. A method by which a downloading computer downloads a target file quickly and securely from a source computer, said method comprising the steps of:
piecewise downloading the target file in a plurality of chunks; and
verifying the integrity of each chunk by calculating a digest for each chunk and comparing the calculated digest with a prestored digest for that chunk.

38. A target computer file prepared for quick and secure download from a source computer, said target computer file comprising:
a plurality of chunks;
a digital signature affixed to each chunk; and
a header containing a chunk size and having a preselected maximum number of bytes.

39. A target computer file prepared for quick and secure download from a source computer, said target computer file comprising:
a plurality of chunks, each chunk except for a last chunk having N bytes, where N is an integer greater than 1; and
associated with the target file, a manifest file containing a digest for each chunk, and further containing N and an overall number of bytes S of the target file.

40. A method by which a software publisher prepares a target file to be downloaded quickly and securely from a source computer, said method comprising the steps of:
breaking up the target file into a plurality of chunks;
digitally signing each chunk;
placing a chunk size into a header of the target file; and
imposing a maximum on the number of bytes in the header.

41. The method of claim 40 wherein the source computer is untrusted.
